(19) United States
(12) Patent Application Publication
(10) Pub. No.: US 2013/0100790 A1
(43) Pub. Date: Apr. 25, 2013

(54) Optical beam positioning at radial location of optical disc using series of segments at edge of optical disc

(71) Applicant: Hewlett-Packard Development Company, L.P., Houston, TX (US)

(72) Inventor: Darwin Mitchel Hanks, Fort Collins, CO (US)

(73) Assignee: Hewlett-Packard Development Company, L.P., Houston, TX (US)

(21) Appl. No.: 13/707,894

(22) Filed: Dec. 7, 2012

Related U.S. Application Data
(63) Continuation of application No. 10/347,074, filed on Jan. 17, 2003, now abandoned.

(51) Int. Cl. G11B 27/36

(52) U.S. Cl. CPC G11B 27/36
USPC 369/53.2

(57) ABSTRACT

A reference pattern on the non-data side (or label side) of an optical data storage disc enables optical disc devices to register a position of a laser to an absolute radial location on the disc's non-data side. The absolute radial location serves as a reference track to which that all radial positioning can be referenced.

### RELATED APPLICATIONS AND PRIORITY CLAIM

The present patent application is a continuation of the patent application filed on Jan. 17, 2003, having the first named inventor Darwin Mitchel Hanks, and assigned application Ser. No. 10/347,074.

### TECHNICAL FIELD

The present disclosure relates generally to optical discs, and more particularly, to determining a radial position on a trackless surface of an optical disc.

### BACKGROUND

An optical disc, such as a compact disc (CD), is an electronic data storage medium that can be written to and read using a low-powered laser beam. Optical disc technology first appeared in the marketplace with the CD, which is typically used for electronically recording, storing, and playing back audio, video, text, and other information in digital form. A digital versatile disc (DVD) is another more recent type of optical disc that is generally used for storing and playing back movies because of its ability to store much more data in the same space as a CD.

CDs were initially a read-only storage medium that stored digital data as a pattern of bumps and flat areas impressed into a piece of clear polycarbonate plastic through a complex manufacturing process. However, average consumers can now burn their own CDs with CD players capable of burning digital data into CD-Rs (CD-recordable discs) and CD-RWs (CD-rewritable discs). CD-Rs have a layer of translucent photosensitive dye that turns opaque in areas that are heated by a laser. Areas of opaque and translucent dye vary the disc reflectivity which enables data storage in a permanent manner analogous to the bumps and flat areas in conventional CDs. CD-RWs represent the bumps and flat areas of conventional CDs through phase shifts in a special chemical compound. In a crystalline phase the compound is translucent, while in an amorphous phase it is opaque. By shifting the phase of the compound with a laser beam, data can be recorded onto and erased from a CD-RW.

Methods for labeling the non-data side of such optical discs with text and images, for example, have continued to develop as consumers desire more convenient ways to identify the data they've burned onto their own CDs. Basic methods for labeling a disc include physically writing on the non-data side with a permanent marker (e.g., a sharpie marker) or printing out a paper sticker label and sticking it onto the non-data side of the disc. Other physical marking methods developed for implementation in conventional CD players include ink jet, thermal wax transfer, and thermal dye transfer methods. Still other methods use the laser in a conventional CD player to mark a specially prepared CD surface. Such methods apply equally to labeling CDs and DVDs.

A problem with labeling CDs is that there are no tracks or other markings on the label surface (i.e., the non-data side, or top side) of the CD to determine radial positioning. Therefore, the radial positioning of a laser spot, for example, to begin printing a label or to append a previously marked label can result in misapplied labels. For example, a label may overlap onto itself if the label data is printed at a radius that is too close to the inner diameter of the disc. Likewise, a label may have gaps if the label data is printed at a radius that is too far from the inner diameter of the disc.

Accordingly, the need exists for a way to determine radial positioning on an optical disc surface that has no tracks or other markings, such as the non-data or label surface of an optical disc.

### SUMMARY

A reference pattern on the non-data side of an optical disc can be scanned and used to position a laser spot at an absolute radial position on the disc.

### BRIEF DESCRIPTION OF THE DRAWINGS

The same reference numbers are used throughout the drawings to reference like components and features.

FIG. 1 illustrates an exemplary environment for implementing radial position registration on a trackless optical disc surface.

FIG. 2 illustrates an exemplary embodiment of an optical disc device suitable for implementing radial position registration on a trackless optical disc surface.

FIG. 3 illustrates an exemplary embodiment of an optical data storage disc having an exemplary reference pattern on a non-data side.

FIGS. 4, 5, and 6 illustrate examples of using a reference pattern to generate a signal whose duty cycle is used to register an absolute radial position on an optical data storage disc.

FIG. 7 illustrates an exemplary embodiment of an optical data storage disc having another exemplary reference pattern on a non-data side.

FIGS. 8, 9, 10, 11, and 12 illustrate examples of using a reference pattern to generate a signal whose amplitude is used to register an absolute radial position on an optical data storage disc.

FIGS. 13, 14, and 15 are flow diagrams illustrating example methods for registering a radial position on a trackless optical disc surface.

### DETAILED DESCRIPTION

Overview

The following discussion is directed to systems and methods for determining a radial position on a trackless surface of an optical data storage disc. A reference pattern on the non-data side (or label side) of an optical data storage disc enables optical disc devices to register the position of a laser to an absolute radial location on the disc's non-data side. The absolute radial location serves as a reference track that all radial positioning can be referenced to. The disclosed systems and methods provide various advantages including, for example, an assurance that label writing to the non-data side of the disc begins at a correct radius that is not too close to either the inner or outer diameter of the disc, and that labels can be updated or appended after a disc has been removed from a disc device by referencing an absolute radial position.

Exemplary Environment

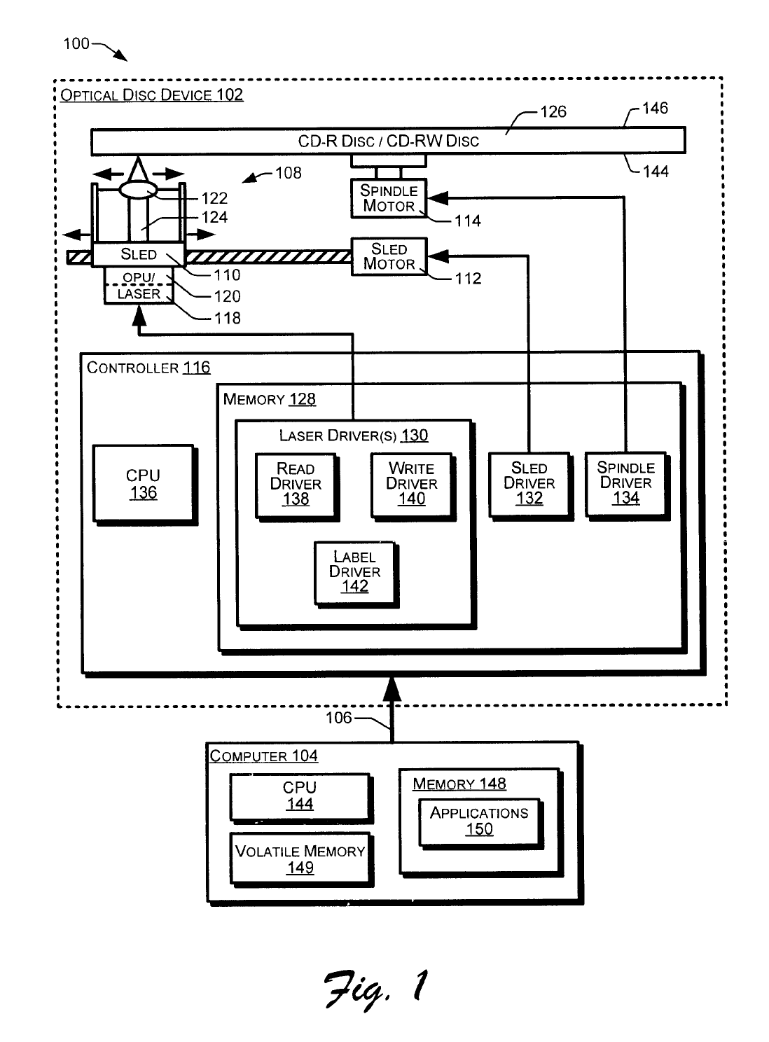

FIG. 1 illustrates an exemplary environment for implementing one or more embodiments of a system for radial position registration on a trackless optical disc surface. The exemplary environment 100 of FIG. 1 includes an optical disc device 102 operatively coupled to a host computer or recording system 104 through a network 106.

Network 106 is typically an ATAPI (Advanced Technology Attachment Packet Interface) device interface, which is one of many small computer parallel or serial device interfaces. Another common computer interface is SCSI (small computer system interface), which is a generalized device interface for attaching peripheral devices to computers. SCSI defines the structure of commands, the way commands are executed, and the way status is processed. Various other physical interfaces include the Parallel Interface, Fiber Channel, IEEE 1394, USB (Universal Serial Bus), and ATA/ATAPI. ATAPI is a command execution protocol for use on an ATA interface so that CD-ROM and tape drives can be on the same ATA cable with an ATA hard disk drive. ATAPI devices generally include CD-ROM drives, CD-Recordable drives, CD-Rewritable drives, DVD (digital versatile disc) drives, tape drives, super-floppy drives (e.g., ZIP and LS-120), and so on.

Optical disc device 102 is typically implemented as a writable CD (compact disc) player/drive that has the ability to write data onto an optical disc such as a CD-R (CD-recordable disc) and a CD-RW (CD-rewritable disc). Such writable CD devices 102 are often called CD burners. More generally, an optical disc device 102 may include, for example, a stand-alone audio CD player that is a peripheral component in an audio system, a CD-ROM drive integrated as standard equipment in a PC (personal computer), a DVD (digital versatile disc) player, and the like. Therefore, although optical disc device 102 is discussed herein as being a CD player/burner, optical disc device 102 is not limited to such an implementation.

As illustrated in FIG. 1, an exemplary optical disc device 102, such as a CD burner, generally includes a laser assembly 108, a sled 110 or carriage for laser assembly 108, a sled motor 112, a disc or spindle motor 114, and a controller 116. Laser assembly 108 mounted on sled 110 includes a laser source 118, an optical pickup unit (OPU) 120, and a focusing lens 122 to focus a laser beam 124 to a laser spot on a writable CD 126 (e.g., a CD-R or CD-RW). OPU 120 further includes four photodiodes and a beam splitter (not shown) for tracking and focus feedback. In general, tracking the data side (144) of a conventional disc 126 with laser assembly 108 for reading and writing data is based on radial position registration information that is readily available from a continuous data track that spirals out from the center of the disc 126. Tracking is achieved through a conventional push-pull tracking scheme involving sensing reflected interference with the four photodiodes.

Controller 116 typically includes a memory 128 such as Random Access Memory (RAM) and/or non-volatile memory for holding computer/processor-readable instructions, data structures, program modules, an image to be printed as a label on disc 126, and other data for controller 116. Accordingly, memory 128 includes laser/OPU drivers 130, sled driver 132, and spindle driver 134. Sled driver 132 and spindle driver 134 execute in conjunction on processor 136 to control, respectively, the radial position of laser assembly 108 with respect to disc 126 and the rotational speed of disc 126. The speed of the disc 126 and radial location of laser assembly 108 are typically controlled so that data on the disc moves past the laser beam 124 at a constant linear velocity (CLV).

Laser/OPU drivers 130 include a read driver 138, a write driver 140, and a label driver 142. Laser/OPU drivers 130 are executable on processor 136 to control laser 118 and OPU 120 when reading data from the data side 144 of disc 126, writing data to the data side 144 of disc 126, and writing a label (e.g., text, graphics) to the non-data side 146 (i.e., the top side or label side) of disc 126 when the disc is flipped over in optical disc device 102. While spindle driver 134 and sled driver 132 rotate data on disc 126 past laser beam 124 at CLV, read driver 138 controls OPU 120 and the intensity of the laser 118 output to read the data by sensing light reflected off the metallic reflective layer of disc 126 (i.e., a CD-R disc) or the phase-change layer of disc 126 (i.e., a CD-RW disc). Similarly, write driver 140 controls OPU 120 and the intensity of the laser 118 output to write data to disc 126. In response to data from write driver 140, laser 118 generates pulsating laser beams 124 to record data onto the data side 144 of a disc 126.

Label driver 142 is configured to execute on processor 136 when a disc 126 is flipped over in the optical disc device 102 so the non-data side 146 of the disc 126 is facing the laser assembly 108. In general, label driver 142 receives label data (e.g., text data, image data) from computer 104 that it uses to control laser 118 for writing a label into the non-data side 146 of disc 126. In response to data from label driver 142, laser 118 generates pulsating laser beams 124 to record label data onto the non-data side 146 of disc 126. However, the conventional push-pull tracking scheme mentioned above for tracking the data side of a disc 126 is not available for tracking the non-data side 146 of the disc 126 because conventional discs (e.g., CD-Rs, CD-RWs, DVDs) have no tracks or other radial position registration information available on their non-data sides 146. Accordingly, the exemplary embodiments section below discusses a radial position registration on a trackless surface of an optical data storage disc 126.

Computer 104 can be implemented as a variety of general purpose computing devices including, for example, a personal computer (PC), a laptop computer, and other devices configured to communicate with optical disc device 102. Computer 104 typically includes a processor 144, a volatile memory 149 (i.e., RAM), and a nonvolatile memory 148 (e.g., ROM, hard disk, floppy disk, CD-ROM, etc.). Nonvolatile memory 148 generally provides storage of computer/processor-readable instructions, data structures, program modules and other data for computer 104. Computer 104 may implement various application programs 150 stored in memory 148 or volatile memory 149 and executable on processor 144 to provide a user with the ability to manipulate or otherwise prepare in electronic form, data such as music tracks to be written to the data side 144 of a disc 126 by disc device 102. Such applications 150 on computer 104 may also enable the preparation of a label, such as text and/or graphics, to be written to the non-data side 146 of a disc 126. In general, computer 104 outputs host data to disc device 102 in a driver format that is suitable for the device 102, which the disc device 102 converts and outputs in an appropriate format onto a writable CD (e.g., CD-R, CD-RW).

Exemplary Embodiments

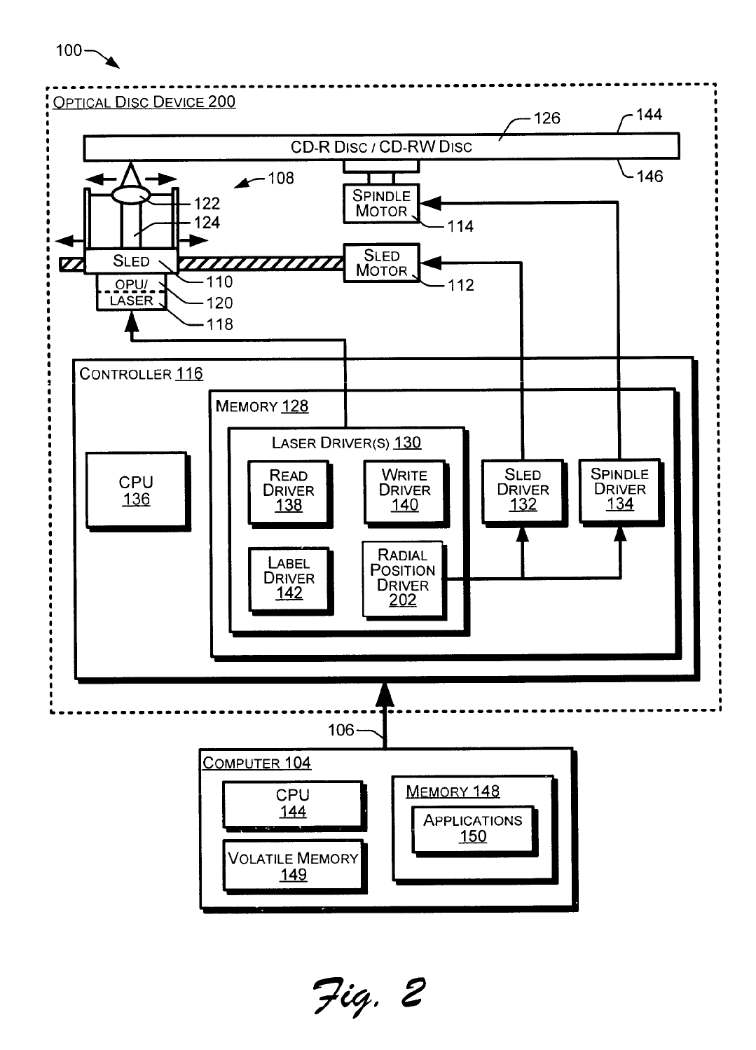

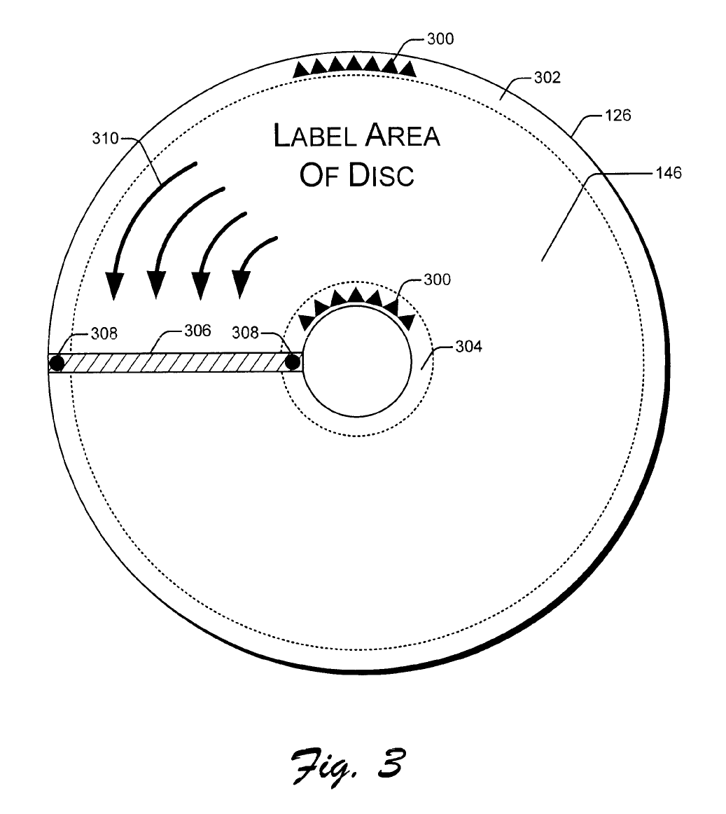

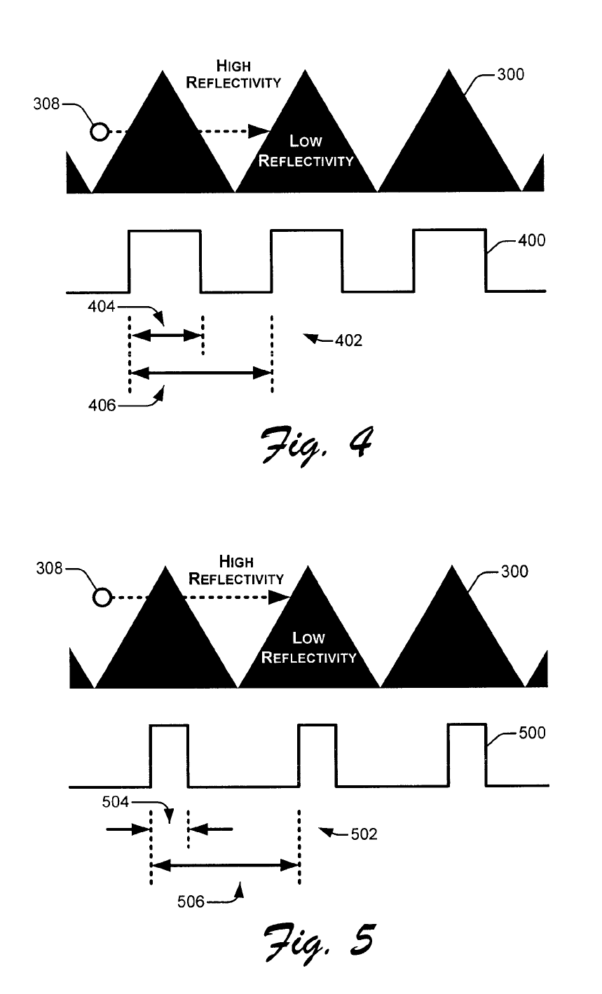

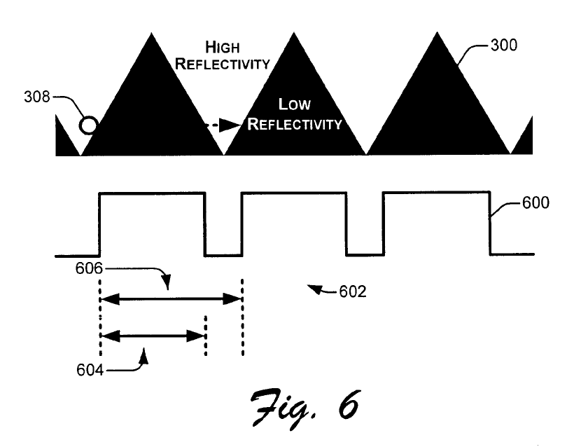

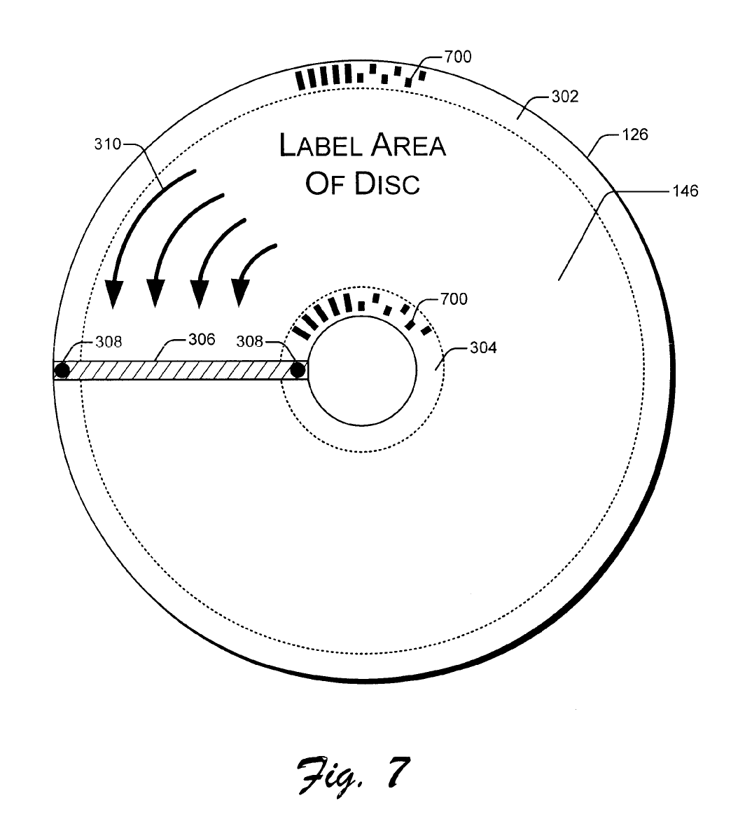

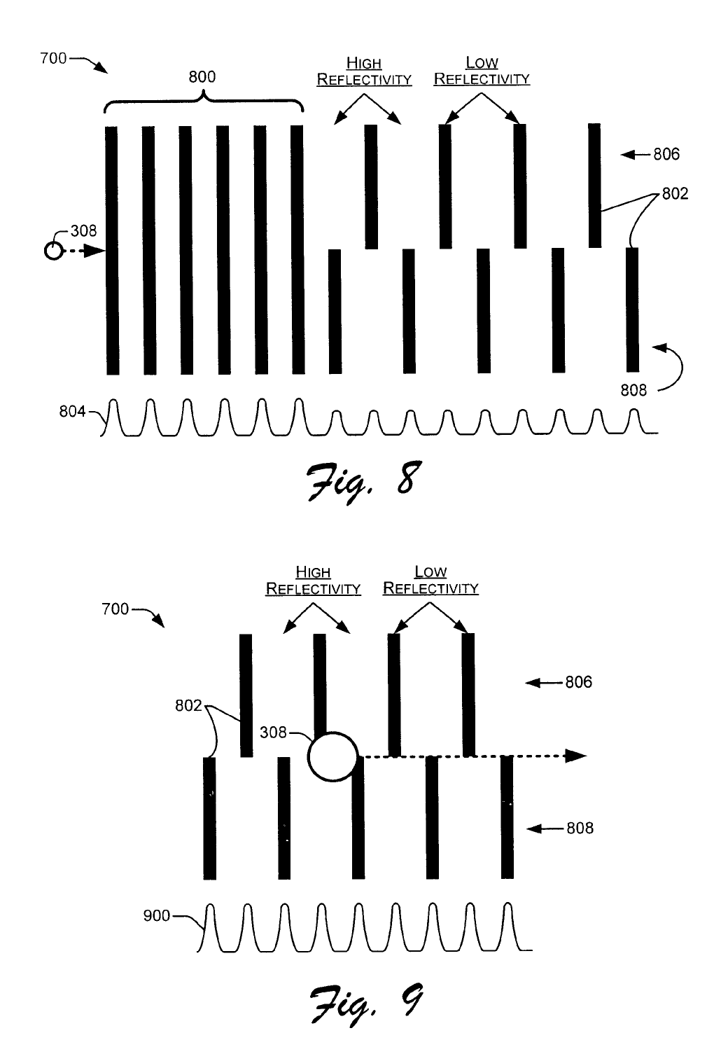

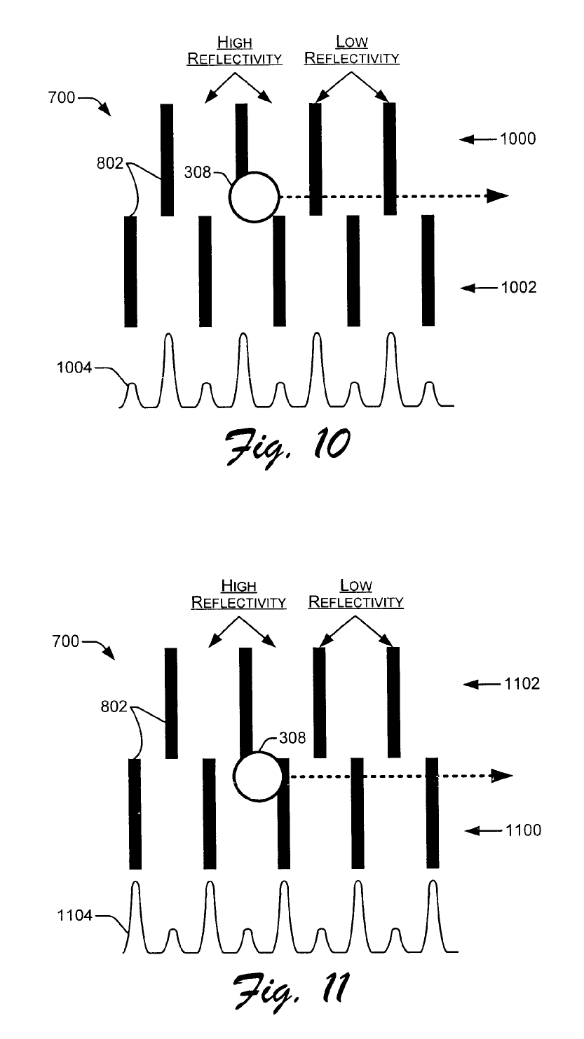

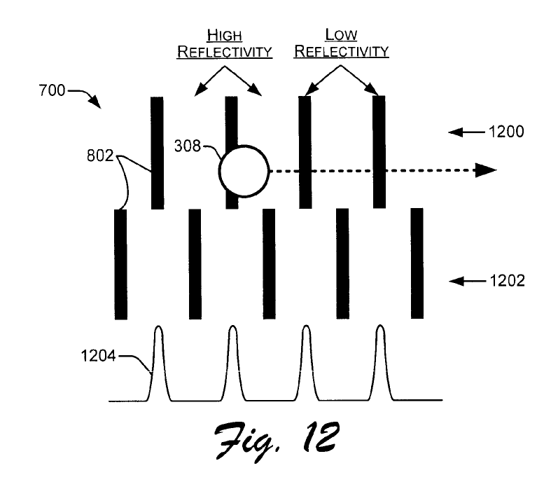

FIG. 2 illustrates an exemplary embodiment of an optical disc device 200 suitable for implementing radial position registration on a trackless optical disc surface (e.g., the non-data side 146 of a disc 126) in an environment 100 such as that discussed above with reference to FIG. 1. The exemplary embodiment of the optical disc device 200 in FIG. 2 is configured in the same manner as the optical disc device 102 of FIG. 1, with the exception of radial position driver 202 stored in memory 128 and executable on processor 136. In addition, the exemplary embodiment of the optical disc device 200 presumes that an optical data storage disc 126 is inserted in the device 200 with the non-data side 146 toward the laser assembly 108 (i.e., with the top side 146 of the disc 126 facing down). Furthermore, the exemplary embodiment of the optical disc device 200 presumes that an optical data storage disc 126 may include a reference pattern on its non-data side 146.

Radial position driver 202 is generally configured to determine whether or not an optical disc 126 includes a reference pattern on its non-data side 146 from which an absolute radial position can be determined. To this end, radial position driver 202 controls spindle motor 114, sled motor 112, and laser assembly 108 in a manner similar to that discussed above in order to scan the disc 126 for a reference pattern or some other mark that indicates a reference pattern is present on the non-data side 146 of disc 126. If a reference pattern is present, radial position driver 202 controls spindle motor 114, sled motor 112, and laser assembly 108 to scan the reference pattern and register the laser beam 124 (i.e., the laser spot from the laser beam 124) to an absolute radial position with respect to the disc 126. The registration process is discussed further below with regard to two exemplary reference patterns.

FIG. 3 illustrates one embodiment of an optical data storage disc 126 having an exemplary reference pattern on a non-data side 146 that enables registration of an absolute radial position by the optical disc device 200 of FIG. 2. The non-data side 146 (i.e., the label side) of the disc 126 is displayed in FIG. 3. The FIG. 3 embodiment shows reference pattern 300 as a sawtooth pattern located in a region on disc 126 at an extreme outer diameter 302 and an extreme inner diameter 304. Although the reference pattern 300 is shown in both locations 302 and 304 in the FIG. 3, in some circumstances the pattern 300 may only be located in one or the other of these locations, and not both. Furthermore, the inner and outer diameters, 302 and 304, are preferred locations for a reference pattern 300 in order that the label area of the disc 126 can remain free for labeling. However, it is noted that this description is not intended to limit the location of reference patterns to the inner and outer diameters 302 and 304 of disc 126, and that such patterns might also be located elsewhere on disc 126.

FIG. 3 further illustrates part of the sled mechanism 306 shown in FIGS. 1 and 2 over which a sled 110 carries a laser assembly 108. At either end of this sled mechanism 306, and in both the extreme outer diameter 302 and extreme inner diameter 304 regions of disc 126, a laser spot 308 is shown. Direction arrows 310 indicate the direction of rotation of disc 126. Although not to scale, laser spot 308 is intended to illustrate how a reference pattern 300 is scanned as the disc 126 rotates the pattern 300 past the laser spot 308, either on the extreme inner diameter 304 or the extreme outer diameter 302 of the disc 126.

The patterns of light and dark in the reference pattern 300 (see also FIGS. 4-6) can be formed on disc 126 by various processes such as silk screening, etching or embossing. The dark patterned areas of reference pattern 300 represent dull areas of low reflectivity (FIGS. 4-6) on disc 126, while the light patterned areas (i.e., the areas that are not marked) represent shiny areas of high reflectivity (FIGS. 4-6) on disc 126. In general, scanning areas of varying reflectivity on a disc 126 generates a reflectivity signal through the OPU 120 (FIG. 2) whose amplitude changes in response to the changing reflectivity of the disc 126.

The exemplary sawtooth pattern 300 of FIG. 3 is further illustrated in FIGS. 4-6. FIGS. 4-6 demonstrate the use of the sawtooth pattern 300 to register or determine an absolute/reference radial position of a laser beam 124 (i.e., the laser spot 308 of FIG. 3) in the optical disc device 200 of FIG. 2 based on the timing of pulses in a reflectivity pattern. The absolute/reference radial position is a radial location within the reference pattern 300 that can be used as a reference track to which all radial positioning can be referenced. Each of the FIGS. 4-6 illustrates the exemplary sawtooth pattern, a reflectivity signal response generated by the OPU 120 (FIG. 2) when the laser assembly 108 scans the pattern with a laser spot 308, and the relative pulse durations of the reflectivity signal. As shown in FIGS. 4-6, the peaks and valleys of the sawtooth pattern 300 define a slanted interface between the low reflectivity region and the high reflectivity region of disc 126.

FIG. 4 illustrates the case where the laser spot 308 is located at the absolute/reference radial position. As the laser spot 308 moves between the low and high reflectivity regions in the sawtooth pattern 300 on disc 126, the OPU 120 generates a reflectivity signal 400 based on the amount of light reflecting off the disc 126. Because the laser spot 308 in FIG. 4 is centered midway between the peaks and valleys of the sawtooth pattern 300, the reflectivity signal 400 has a (nearly) 50% duty cycle. That is, the ratio of the pulse duration 404 to the pulse period 406 is (nearly) 50%. The pulses 402 in the reflectivity signal 400 of FIG. 4 are rectangular in shape (i.e., saturated at the top and bottom) because the laser spot 308 is very small by comparison to the sawtooth pattern 300, and it is therefore either completely within a low reflectivity region or completely within a high reflectivity region as it scans the pattern 300. In addition, the laser spot 308 is traveling very fast relative to the sawtooth pattern 300 and therefore traverses the interface between the low and high reflectivity regions virtually instantaneously. Thus, transitions between high and low signal saturations in the reflectivity signal 400 are also virtually instant, and they appear as straight vertical lines.

It is noted that the sawtooth pattern 300 is only one example of a pattern that may achieve this type of response, and that other patterns having similarly slanted interfaces between two surfaces of different reflectivities relative to the radius of the disc 126 might also be useful to produce similar results.

Referring again to the particular optical disc device embodiment of FIG. 2, the radial position driver 202 is further configured to analyze the duty cycle of the reflectivity signal 400 as the reference pattern 300 is being scanned, and to adjust the laser assembly 108 position (i.e., the laser spot 308 position) by controlling the sled motor 114 until the duty cycle is brought within a given threshold range. If the duty cycle is below the threshold range, the laser assembly 108 (laser spot 308) is moved in a first direction that brings the duty cycle within the threshold range. If the duty cycle is above the threshold range, the laser assembly (laser spot 308) is moved in a second direction that brings the duty cycle within the threshold range. The threshold range for the duty cycle is typically set to be within a percentage point or two around 50% (e.g., 49% to 51% duty cycle range).

FIG. 5 illustrates the case where the laser spot 308 is located higher on the sawtooth pattern 300 than the absolute/reference radial position. That is, the laser spot 308 is at a radial distance that is too far from the inner diameter of the disc 126. As discussed above, in this scenario the radial position driver 202 measures pulse widths 502 to analyze the duty cycle (i.e., the ratio of the pulse duration 504 to the pulse period 506) and determine if the laser spot 308 needs an adjustment toward the absolute/reference radial position. It is clear from FIG. 5 that the laser spot 308 is not positioned midway between the peaks and valleys of the sawtooth pattern 300. Rather, the laser spot 308 is positioned too near the peaks of the low reflectivity region of the sawtooth pattern 300. The duty cycle for the reflectivity signal 500 illustrates this because the ratio of pulse duration 504 to pulse period 506 is significantly below 50%. Upon determining that the duty cycle is below a given threshold (e.g., 49% to 51%), the radial position driver 202 controls the sled motor 112 (FIG. 2) to adjust the laser assembly 108 position (i.e., the laser spot 308 position) until the duty cycle is brought within the given threshold range.

FIG. 6 illustrates the case where the laser spot 308 is located lower on the sawtooth pattern 300 than the absolute/reference radial position. That is, the laser spot 308 is at a radial distance that is too close to the inner diameter of the disc 126. As discussed above, in this scenario the radial position driver 202 measures pulse widths 602 to analyze the duty cycle (i.e., the ratio of the pulse duration 604 to the pulse period 606) and determine if the laser spot 308 needs an adjustment toward the absolute/reference radial position. It is clear from FIG. 6 that the laser spot 308 is not positioned midway between the peaks and valleys of the sawtooth pattern 300. Rather, the laser spot 308 is positioned too near the peaks of the high reflectivity region of the sawtooth pattern 300.

The duty cycle for the reflectivity signal 600 illustrates this because the ratio of pulse duration 604 to pulse period 606 is significantly above 50%. Upon determining that the duty cycle is above a given threshold (e.g., 49% to 51%), the radial position driver 202 controls the sled motor 112 (FIG. 2) to adjust the laser assembly 108 position (i.e., the laser spot 308 position) until the duty cycle is brought within the given threshold range.

FIG. 7 illustrates another embodiment of an optical data storage disc 126 having an exemplary reference pattern on a non-data side 146 of the disc 126 which enables registration of an absolute radial position by the optical disc device 200 of FIG. 2. As in FIG. 3 above, the non-data side 146 (i.e., the label side) of the disc 126 is displayed in FIG. 7. The exemplary reference pattern 700 of the FIG. 7 embodiment includes alternating bars of low and high reflectivity regions that form a timing synchronization field, and two rows of adjacent half bars that are 180 degrees out of phase with one another as shown in FIGS. 8-12. Reference pattern 700 is located on the disc 126 in the same manner as that discussed above with respect to the reference pattern 300 of FIG. 3. Thus, the alternating bar pattern 700 is typically located toward the extreme outer 302 and/or extreme inner 304 diameter of disc 126.

Like FIG. 3 above, FIG. 7 further illustrates part of the sled mechanism 306 for carrying a laser assembly 108 between the extreme diameters of disc 126. A laser spot 308 and direction arrows 310 illustrate how the reference pattern 700 is scanned as the disc 126 rotates the pattern 700 past the laser spot 308, either at extreme inner diameter 304 or extreme outer diameter 302 of the disc 126.

The exemplary bar pattern 700 of FIG. 7 is fully illustrated in FIG. 8 as including synchronization field 800 and the two half rows of stacked bars 802. FIGS. 9-12 do not show the synchronization field 800 in pattern 700. However, the exclusion of synchronization field 800 in the patterns 700 of FIGS. 9-12 is for purposes of illustration only, and is not intended to indicate that the synchronization fields 800 are absent from these patterns 700.

In the exemplary bar pattern 700 of FIG. 7, the radial reference position is an imaginary line between the two rows of adjacent half bars 802 as shown in FIGS. 8-12. Referring to FIG. 8, a laser spot 308 first scans over synchronization field 800. The reflectivity signal 804 generated by the OPU 120 (FIG. 2) while scanning the synchronization field 800 provides frequency information that is useful for analyzing the latter portion of the reflectivity signal 804 generated from scanning the two rows of adjacent half bars 802. For example, the frequency/timing information from the synchronization field 800 indicates which subsequent amplitude pulses in reflectivity signal 804 belong with the top half 806 of the half bars 802 and which subsequent amplitude pulses in reflectivity signal 804 belong with the bottom half 808 of the half bars 802.

FIG. 9 is a magnified view of the latter part of the FIG. 8 scan of pattern 700. It is clear from FIG. 9 that the laser spot 308 is traversing the pattern 700 at the midway point between the two rows 806 and 808, of adjacent half bars 802. Therefore, the laser spot 308 encounters low and high reflectivity bars equally, and the amplitude pulses in the reflectivity signal 804 generated by OPU 120 are all equal. Accordingly, the laser spot 308 is properly positioned at the radial reference position, and the radial position driver 202 (FIG. 2) does not need to make any correction to the laser assembly 108 radial position (i.e., the laser spot 308 radial position).

However, FIG. 10 illustrates the case where the laser spot 308 is located higher on the exemplary bar pattern 700 than the absolute/reference radial position. That is, the laser spot 308 is at a radial distance that is too far from the inner diameter of the disc 126. Therefore, the laser spot 308 encounters low reflectivity bars in the top half 1000 of the bar pattern 700 to a greater degree than it does in the bottom half 1002. The resulting reflectivity signal 1004 generated by the OPU 120 (FIG. 2) has larger amplitude pulses associated with the top half 1000 of the bar pattern 700 than with the bottom half 1002.

When analyzing the reflectivity signal 1004, the radial position driver 202 (FIG. 2) samples every other amplitude pulse in signal 1004 (i.e., at half the frequency of the previously scanned synchronization field 800 frequency) for both the top half 1000 and bottom half 1002 of the bar pattern 700. Radial position driver 202 then calculates an average amplitude for both the top half 1000 and bottom half 1002 of the bar pattern 700 and compares the averages. The radial position driver 202 then drives the sled motor 112 to adjust the laser assembly 108 position (i.e., the laser spot 308 position) downward (i.e., radially inward) until the laser spot 308 reaches the absolute/reference radial position and the average reflectivity signal amplitudes for the top half 1000 and bottom half 1002 of the bar pattern 700 are equal or fall within a minimum threshold difference.

FIG. 11 illustrates the case where the laser spot 308 is located lower on the exemplary bar pattern 700 than the absolute/reference radial position. That is, the laser spot 308 is at a radial distance that is too close to the inner diameter of the disc 126. Therefore, the laser spot 308 encounters low reflectivity bars in the bottom half 1100 of the bar pattern 700 to a greater degree than it does in the top half 1102. The resulting reflectivity signal 1104 generated by the OPU 120 (FIG. 2) has larger amplitude pulses associated with the bottom half 1100 of the bar pattern 700 than with the top half 1102.

The radial position driver 202 (FIG. 2) analyzes the reflectivity signal 1104 by sampling every other amplitude pulse in signal 1104 (i.e., at half the frequency of the previously scanned synchronization field 800 frequency) for both the top half 1102 and bottom half 1100 of the bar pattern 700. Radial position driver 202 then calculates an average amplitude for both the top half 1102 and bottom half 1100 of the bar pattern 700 and compares the averages. The radial position driver 202 then drives the sled motor 112 to adjust the laser assembly 108 position (i.e., the laser spot 308 position) upward (i.e., radially outward) until the laser spot 308 reaches the absolute/reference radial position and the average reflectivity signal amplitudes for the top half 1000 and bottom half 1002 of the bar pattern 700 are equal or fall within a minimum threshold difference.

FIG. 12 illustrates another case where the laser spot 308 is located higher on the exemplary bar pattern 700 than the absolute/reference radial position. That is, the laser spot 308 is at a radial distance that is too far from the inner diameter of the disc 126. In this case, the laser spot 308 is located completely within the top half 1200 of bar pattern 700. Therefore, the laser spot 308 encounters low reflectivity bars in the top half 1200 of the bar pattern 700 and none in the bottom half 1202. The resulting reflectivity signal 1204 generated by the OPU 120 (FIG. 2) is therefore half the frequency of the previously scanned synchronization field 800 (FIG. 8), and only has amplitude pulses associated with the top half 1200 of the bar pattern 700 while no amplitude pulses are associated with the bottom half 1202. The phase of the amplitude pulses in the reflectivity signal 1204 therefore identify the pulses as being associated with the top half 1200 of the bar pattern 700.

The radial position driver 202 (FIG. 2) samples every other amplitude pulse in signal 1204 (i.e., at half the frequency of the previously scanned synchronization field 800 frequency—see FIG. 8) for both the top half 1200 and bottom half 1202 of the bar pattern 700. The radial position driver 202 monitors the frequency of the amplitude pulses in the reflectivity signal 1204, which is only half the frequency of the previously scanned synchronization field 800. The radial position driver 202 also determines the phase of the amplitude pulses in the reflectivity signal 1204 from the previously scanned synchronization field 800. The phase of the amplitude pulses indicates that they are associated with the top half 1200 of the bar pattern 700 only. Based on the frequency and phase of the amplitude pulses in the reflectivity signal 1204, the radial position driver 202 drives the sled motor 112 to adjust the laser assembly 108 position (i.e., the laser spot 308 position) downward (i.e., radially inward) until the laser spot 308 reaches the absolute/reference radial position and the average reflectivity signal amplitudes for the top half 1200 and bottom half 1202 of the bar pattern 700 are equal or fall within a minimum threshold difference.

Exemplary Methods

Example methods for registering a radial position on a trackless optical disc surface will now be described with primary reference to the flow diagrams of FIGS. 13-15. The methods apply generally to the exemplary embodiments discussed above with respect to FIGS. 2-12. The elements of the described methods may be performed by any appropriate means including, for example, by hardware logic blocks on an ASIC or by the execution of processor-readable instructions defined on a processor-readable media, such as a disk, a ROM or other such memory device.

FIG. 13 shows an exemplary method 1300 for registering a radial position on a trackless optical disc surface such as a CD-R, a CD-RW, a CD-ROM and a DVD. At block 1302, a reference pattern is located on the optical disc. The reference pattern is located on the non-data or label side of the disc. The reference pattern is typically located at either the extreme inner diameter of the disc or at the extreme outer diameter of the disc. Location of the reference pattern is done on an optical disc device such as a CD player that includes a CD burner capability. Location of the reference pattern occurs when the optical disc is placed in the optical disc device upside down so the device laser assembly has access to scan the non-data side of the disc.

At block 1304, the reference pattern is scanned with a laser spot. The laser assembly shines a laser beam onto the disc at the reference pattern and an optical pickup unit generates a reflectivity signal based on the light reflecting off the reference pattern and the disc surface.

At block 1306, the laser spot (laser beam) is positioned at a radial reference position based on position data from the scan of the reference pattern. The laser is positioned by analyzing the reflectivity signal generated from the reference pattern scan. Depending on the reference pattern, the laser positioning may be accomplished based on the amplitude pulses of the reflectivity signal or the duty cycle of the reflectivity signal.

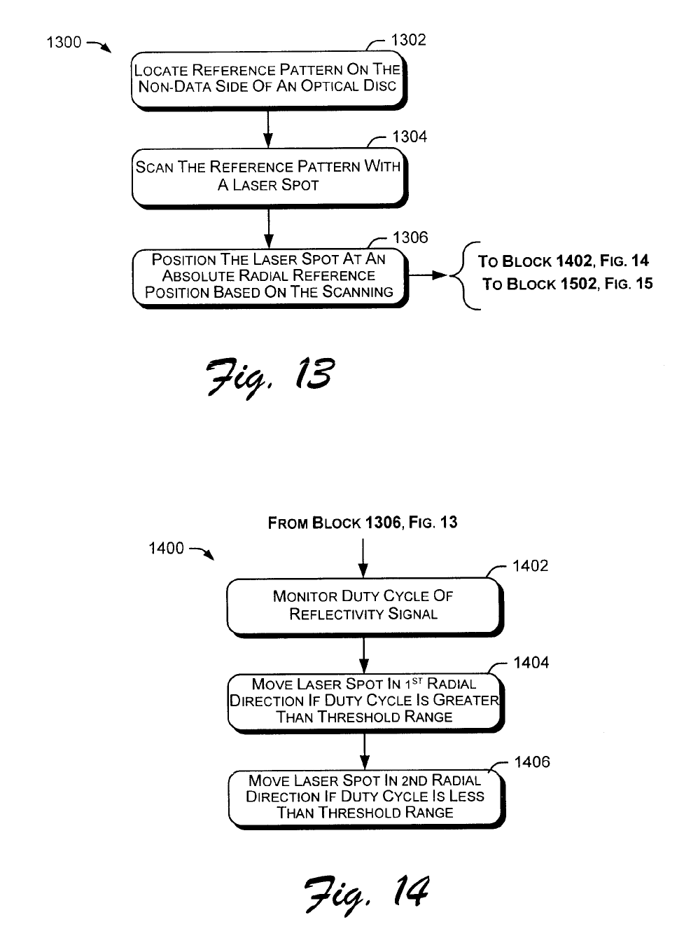

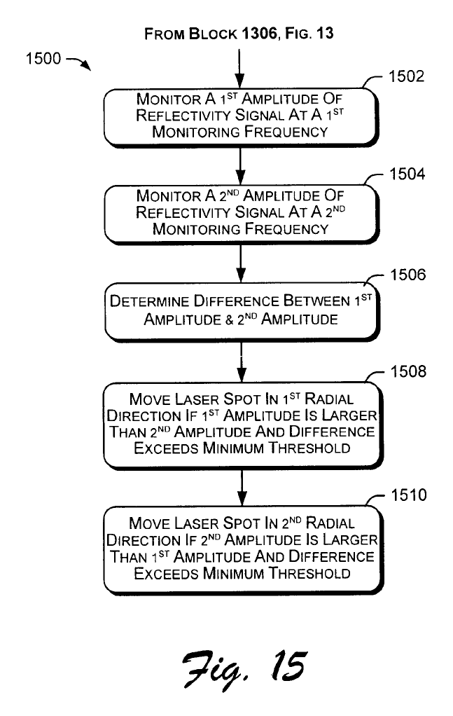

The method 1300 of FIG. 13 continues from block 1306 with method 1400 in FIG. 14 and method 1500 in FIG. 15. FIG. 14 therefore shows a continuation of an exemplary method 1400 for registering a radial position on a trackless optical disc surface.

At block 1402 of method 1400, the duty cycle of a reflectivity signal is monitored. As discussed above, the reflectivity signal is generated by the optical pickup unit during a scan of a reference pattern located on the non-data side of an optical disc. The particular type of reference pattern being used in this method is a sawtooth pattern that generates a reflectivity whose duty cycle can be used to register a radial position on an optical disc surface.

At block 1404, the laser spot is moved in a first radial direction if the duty cycle of the reflectivity signal is greater than a given threshold range. A duty cycle of 50% means the laser spot is located precisely at the radial reference position and that no radial adjustment of the laser spot is needed. The threshold range above or below which the radial position of the laser spot should be adjusted is typically from about 49% to about 51% duty cycle. At block 1406, the laser spot is moved in a second radial direction if the duty cycle of the reflectivity signal is less than the threshold range.

FIG. 15 also shows a continuation of an exemplary method 1500 for registering a radial position on a trackless optical disc surface. At block 1502 of method 1500, a first amplitude of the reflectivity signal is monitored at a first monitoring frequency. The first monitoring frequency is half of the frequency determined from a synchronization field within an alternating bar reference pattern. Monitoring the reflectivity amplitude at half the signal frequency picks up the amplitude pulses generated from just one side of the reference pattern.

At block 1504, a second amplitude of the reflectivity signal is monitored at a second monitoring frequency. The second monitoring frequency is the same as the first monitoring frequency but is 180 degrees out of phase. Therefore, the amplitude pulses generated from the other side of the reference pattern are picked up.

At block 1506, the difference between the first and second amplitudes is calculated. At block 1508, the laser spot is moved in a first radial direction if the first amplitude is larger than the second amplitude and the difference between the amplitudes exceeds a minimum threshold. At block 1510, the laser spot is moved in a second radial direction if the second amplitude is larger than the first amplitude and the difference between the amplitudes exceeds a minimum threshold. Blocks 1506-1510 determine how far the laser spot is to one side or the other side of the reference pattern being scanned. The farther the laser spot is to one side of the reference pattern, the larger the amplitude difference will be between the reflectivity responses for both sides of the pattern, and the farther the laser will be moved toward the center of the reference pattern. When the laser spot is at the radial reference location in the center of the reference pattern, there will be little or no amplitude differences in the reflectivity signal.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

Additionally, while one or more methods have been disclosed by means of flow diagrams and text associated with the blocks of the flow diagrams, it is to be understood that the blocks do not necessarily have to be performed in the order in which they were presented, and that an alternative order may result in similar advantages.

Furthermore, the methods are not exclusive and can be performed alone or in combination with one another.

We claim:

1. A method for precisely positioning an optical beam of an optical disc device at a predetermined radial location on a non-data side of an optical disc, comprising:
detecting, via the optical beam of the optical disc device, a frequency of a series of segments at an edge of the non-data side of the optical disc, the series of segments including a first series of segments and a second series of segments, the first series and the second series angularly interleaved on the non-data side, the first series non-overlapping the second series radially on the non-data side;
determining whether the frequency is equal to a predetermined frequency corresponding to the optical beam detecting both the first series of segments and the second series of segments; and
in response to determining that the frequency is equal to the predetermined frequency, concluding that the optical beam is located within a predetermined threshold about the predetermined radial location on the non-data side but is not necessarily located precisely at the predetermined radial location.

2. The method of claim 1, further comprising, in response to determining that the frequency is equal to the predetermined frequency:
determining, via the optical beam of the optical disc device, a first amplitude corresponding to an extent of overlap of the optical beam on the first series of segments and a second amplitude corresponding to an extent of overlap of the optical beam on the second series of segments;
determining whether the first amplitude is equal to the second amplitude; and
in response to determining that the first amplitude is equal to the second amplitude, concluding that the optical beam is precisely located at the predetermined radial location.

3. The method of claim 2, further comprising, in response to determining that the first amplitude is unequal to the second amplitude:
moving the optical beam of the optical disc device radially on the non-data side of the optical disc by a distance corresponding to a difference between the first amplitude and the second amplitude.

4. The method of claim 3, further comprising, after moving the optical beam by the distance:
repeating the method at detecting the frequency of the series of segments.

5. The method of claim 1, further comprising, in response to determining that the frequency is unequal to the predetermined frequency:
concluding that the optical beam is located outside the predetermined threshold about the predetermined radial location and is detecting one but not both of the first series of segments and the second series of segments.

6. The method of claim 5, further comprising, in response to determining that the frequency is unequal to the predetermined frequency:
moving the optical beam of the optical disc device radially on the non-data side of the optical disc by a predetermined coarse distance; and
repeating the method at detecting the frequency of the series of segments.

7. The method of claim 1, further comprising, prior to detecting the frequency of the series of segments:
detecting, via the optical beam of the optical disc device, a frequency of an initial series of calibration segments at the edge of the non-data side of the optical disc, the initial series of calibration segments located before the series of segments, the initial series overlapping both the first series and the second series radially on the non-data side; and
setting the predetermined frequency equal to the frequency of the initial series of calibration segments.

8. A non-transitory computer-readable data storage medium storing computer-executable instructions executable by a processing device to perform a method for précising positioning an optical beam of an optical disc device at a predetermined radial location on a non-data side of an optical disc, the method comprising:
detecting, via the optical beam of the optical disc device, a frequency of a series of segments at an edge of the non-data side of the optical disc, the series of segments including a first series of segments and a second series of segments, the first series and the second series angularly interleaved on the non-data side, the first series non-overlapping the second series radially on the non-data side;
determining whether the frequency is equal to a predetermined frequency corresponding to the optical beam detecting both the first series of segments and the second series of segments;
in response to determining that the frequency is equal to the predetermined frequency, determining, via the optical beam of the optical disc device, a first amplitude corresponding to an extent of overlap of the optical beam on the first series of segments and a second amplitude corresponding to an extent of overlap of the optical beam on the second series of segments;
determining whether the first amplitude is equal to the second amplitude; and
in response to determining that the first amplitude is equal to the second amplitude, concluding that the optical beam is precisely located at the predetermined radial location.

9. The non-transitory computer-readable data storage medium of claim 8, wherein the method further comprises, in response to determining that the first amplitude is unequal to the second amplitude:
moving the optical beam of the optical disc device radially on the non-data side of the optical disc by a distance corresponding to a difference between the first amplitude and the second amplitude.

10. The non-transitory computer-readable data storage medium of claim 8, wherein the method further comprises, in response to determining that the frequency is unequal to the predetermined frequency:
moving the optical beam of the optical disc device radially on the non-data side of the optical disc by a predetermined coarse distance; and
repeating the method at detecting the frequency of the series of segments.

11. The non-transitory computer-readable data storage medium of claim 8, wherein the method further comprises, prior to detecting the frequency of the series of segments:
detecting, via the optical beam of the optical disc device, a frequency of an initial series of calibration segments at the edge of the non-data side of the optical disc, the initial series of calibration segments located before the series of segments, the initial series overlapping both the first series and the second series radially on the non-data side; and
setting the predetermined frequency equal to the frequency of the initial series of calibration segments.

12. An optical disc device comprising:
a optical beam source to output an optical beam;
a motor mechanism to rotate an optical disc inserted into the optical disc device and to move the optical beam source radially over a non-data side of the optical disc; and
logic to precisely position the optical beam based on detection via the optical beam of a frequency of a series of segments at an edge of the non-data side of the optical disc, the series of segments including a first series of segments and a second series of segments, the first series and the second series angularly interleaved on the non-data side, the first series non-overlapping the second series radially on the non-data side.

13. The optical disc device of claim 12, wherein the logic is to:
determine whether the frequency is equal to a predetermined frequency corresponding to the optical beam detecting both the first series of segments and the second series of segments;
in response to determining that the frequency is equal to the predetermined frequency, determine, via the optical beam, a first amplitude corresponding to an extent of overlap of the optical beam on the first series of segments and a second amplitude corresponding to an extent of overlap of the optical beam on the second series of segments;
determine whether the first amplitude is equal to the second amplitude; and
in response to determining that the first amplitude is equal to the second amplitude, concluding that the optical beam is precisely located at the predetermined radial location.

14. The optical disc device of claim 13, wherein the logic is further to:
in response to determining that the first amplitude is unequal to the second amplitude, cause the motor mechanism to move the optical beam radially on the non-data side of the optical disc by a distance corresponding to a difference between the first amplitude and the second amplitude; and
in response to determining that the frequency is unequal to the predetermined frequency, cause the motor mechanism to move the optical beam radially on the non-data side of the optical disc by a predetermined coarse distance.

15. The optical disc device of claim 13, wherein the logic is further to:
detect, via the optical beam, a frequency of an initial series of calibration segments at the edge of the non-data side of the optical disc, the initial series of calibration segments located before the series of segments, the initial series overlapping both the first series and the second series radially on the non-data side; and
set the predetermined frequency equal to the frequency of the initial series of calibration segments.

16. An optical disc comprising:
a substrate having a data side and a non-data side; and
a series of segments at an edge of the non-data side of the optical disc at a predetermined frequency, the series of segments including a first series of segments and a second series of segments, the first series and the second series angularly interleaved on the non-data side, the first series non-overlapping the second series radially on the non-data side,
wherein the series of segments is adapted to permit precise positioning of an optical beam of an optical disc device at a predetermined radial location on the non-data side of the optical disc.

17. The optical disc of claim 16, further comprising:
an initial series of calibration segments at the edge of the non-data side of the optical disc at the predetermined frequency, the initial series of calibration segments located before the series of segments, the initial series overlapping both the first series and the second series radially on the non-data side,
wherein the initial series of segments is adapted to permit the optical disc device to determine the predetermined frequency.
